(19) United States
(12) Patent Application Publication
(10) Pub. No.: US 2003/0020839 A1
(43) Pub. Date: Jan. 30, 2003

(54) Integrating filter

(76) Inventor: D. Scott Dewald, Dallas, TX (US)

Correspondence Address: TEXAS INSTRUMENTS INCORPORATED, P O BOX 655474, M/S 3999, DALLAS, TX, 75265

(21) Appl. No.: 10/186,827

(22) Filed: Jul. 1, 2002

Related U.S. Application Data
(60) Provisional application No. 60/301,983, filed on Jun. 30, 2001.

(51) Int. Cl. H04N 9/12

(52) U.S. Cl. 348/743

(57) ABSTRACT

A display system (300) providing the efficiency improvements of sequential color recapture (SCR) display systems without the need for a spiral color wheel. A color filter array (312) is positioned at the exit face of an integrator rod (310). The color filter array (312) filters light reaching the end of the integrator rod (310) into a plurality of colored light beams. The various single color light beams are directed by a scrolling element (322). Scrolling element (322) typically is one or more rotating prisms that cause each single color beam to sweep across the face of the spatial light modulator (116). The preceding abstract of the disclosure is submitted with the understanding that it only will be used to assist in determining, from a cursory inspection, the nature and gist of the technical disclosure as described in 37 C.F.R. § 1.72(b). In no case should this abstract be used for interpreting the scope of any patent claims.

### CROSS-REFERENCE TO RELATED APPLICATIONS

The following patents and/or commonly assigned patents and patent applications are hereby incorporated herein by reference:

| Patent No. | Filing Date | Issue Date | Title |
|---|---|---|---|
| 09/705,467 | Nov. 3, 2000 | | Sequential Color Recapture |
| | | | for Projection Systems |
| 60/258,985 | Dec. 29, 2000 | | Illumination System for |
| | | | Scrolling Color Recycling |

### FIELD OF THE INVENTION

This invention relates to the field of display systems, more particularly to optical systems used in sequential color recycling display systems, more particularly to integrator and color separation systems used in projection display systems.

### BACKGROUND OF THE INVENTION

A schematic view of a traditional field sequential color display system 100 is shown in FIG. 1. In FIG. 1, white light 102 from light source 104 is gathered by reflector 106 and lens 108 and focused onto the entrance face of an integrating rod 110. The white light 102 is reflected several times by the walls of the integrating rod 110, either by mirrored walls or by total internal reflection. The multiple reflections serve to homogenize the light, creating a uniform beam of white light at the exit face of the integrating rod 110.

Light exiting the integrating rod 110 strikes a spinning color wheel 112. The color wheel 112, shown in plan view in FIG. 2, has a quantity of color filter segments and may include a clear segment. The beam of white light strikes the color wheel 112 as the color wheel 112 spins through the stationary light path 202. The characteristics of the filter in the light path 202 determine which wavelengths of light are reflected, absorbed, or transmitted by the color wheel.

Typical color wheels include red, green, and blue segments that transmit a single band of wavelengths—red, green, or blue light—and reflect the remaining wavelengths. When the color wheel of FIG. 2 is used, the filtered light beam is comprised of red, then green, then blue, then white light. Although this disclosure discusses the function of the color filters as producing a single color, or monochromatic light beam, it should be understood that the color filters typically pass light from a band of wavelengths. Thus, when a monochromatic red beam is referred to, what is literally meant is a polychromatic light beam comprised of a band of wavelengths that are collectively perceived as red by a human observer.

As shown in FIG. 1, this sequential color light beam 114 is focused onto a spatial light modulator 116. The spatial light modulator 116 may be any of a variety of modulator types, such as a micromirror device, liquid crystal panel, or a liquid crystal panel on a silicon substrate, or other types of modulators as are known in the art.

A controller 118 supplies image data to the modulator 116 in synchronization with the changing light beam. The modulator 116 selectively reflects portions of the light beam—or in other systems selectively transmits portions of the light beam—to form an image bearing beam of light. The image bearing beam of light is focused by a projection lens 120 onto a display screen 122 or other image plane. Provided the monochromatic images are formed in rapid succession, the viewer's eye integrates the monochromatic images and gives the perception of a full-color image.

Unfortunately, the display system 100 of FIG. 1 is relatively inefficient. Because only a single color band of light is used at any given time—except for during the white segment period—only about one-third of the light created by the light source can be used to form the image.

A recent development in the field of projection displays is the invention and introduction of sequential color recycling (SCR) display systems. SCR display systems provide a mirrored input face on the integrating rod 110. A small region of the input face is necessary to allow light to enter the integrating rod 110 and is not mirrored. The exit face of the integrating rod 110 is placed very close to the spinning color wheel 112.

The color wheel 112 of an SCR system is formed from dichroic filters. Each filter segment is small enough that the light path from the integrating rod passes through all three colors at all times. The light not allowed to pass through the color wheel 112 is reflected to the integrating rod 110. This light travels back through the integrating rod 110 from the exit face to the input face where it may strike the mirrored portion of the input face. Assuming the light strikes the mirrored input face, it travels a third time through the integrating rod, exiting the rod and striking the spinning color wheel 112. If a different dichroic filter happens to be struck by the light, the recycled light is allowed to pass through the color wheel.

The SCR display system described above continuously images each of the primary colors on the modulator surface. As the color wheel turns, these images move from one side of the modulator array to the other, so that the entire modulator is imaged by each color light beam. Image data supplied by the controller 118 is synchronized with the movement of the primary colored light beams. Again, the viewers eye is used to integrate the single colored images to provide the perception of a full color image.

The SCR architecture provides greatly increased image brightness for a fixed lamp size. By recapturing the two-thirds of the light typically lost by sequential color systems, a brightness boost of approximately 40% is realizable. The remaining recaptured light is lost through the aperture on the input face of the integrating rod or through losses caused by the multiple reflections within the integrating rod.

One drawback of the SCR system architecture is the difficulty in imaging the color wheel 112 onto the spatial light modulator 116. When a color wheel with pie-shaped segments, as shown in FIG. 2, is used, the color segments sweep across one side of the modulator at a faster rate than they sweep across the opposite side, making it difficult to map the image data for a particular color to the position of the colored light beam. Even worse, the boundary angle between adjacent colored light beams changes as it sweeps across the modulator. To avoid this, spiral color wheels have been developed. Unfortunately, these color wheels are expensive to produce. What is needed is a simpler method of implementing the SCR architecture.

### SUMMARY OF THE INVENTION

Objects and advantages will be obvious, and will in part appear hereinafter and will be accomplished by the present invention which provides a method and system for scrolling color display systems. One embodiment of the claimed invention provides an integrator rod comprising: an integrator body having an input face and an output face; and a color filter array associated in a fixed position with the output face.

According to another embodiment of the present invention, a display system is provided. The display system comprising: a recycling integrating rod on a light path for spatially filtering light traveling along the light path into at least two colored light beams; a scrolling element for spatially altering the path of the at least two colored light beams; a spatial light modulator receiving and modulating the at least two colored light beams; and optics for focusing the modulated light beams on an image plane. The integrating rod may comprise: an integrator body having an input face and an output face; and a color filter array associated in a fixed position with the output face.

Yet another embodiment of the present invention provides a display system. The display system comprising: a means for recycling and filtering light on a light path operable to filter the light into at least two colored light beams; a scrolling element for spatially altering the path of the at least two colored light beams; a spatial light modulator receiving and modulating the at least two colored light beams; and optics for focusing the modulated light beams on an image plane.

Any one of a variety of spatial light modulators may be used in various embodiments of the present invention, including without limitation: a liquid crystal panel, a liquid crystal panel formed on a silicon substrate, and a micromirror device. The micromirror device may be a digital micromirror device, commonly know as a DMD.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic view of a traditional field sequential color display system of the prior art.

FIG. 2 is a plan view of a typical color wheel of the prior art having eight pie-shaped filter segments.

FIG. 3 is a schematic diagram of a display architecture according to one embodiment of the present invention.

FIG. 4 is a perspective view of a prior art integrating rod showing an aperture on the mirrored input face.

FIG. 5 is a perspective view of one embodiment of light recycling integrator according to the present invention.

FIG. 6 is a side view showing the recycling function of the recycling integrator of FIG. 5.

FIG. 7 is a schematic view of a portion of a display system showing the operation of the scrolling element in combination with a transmissive spatial light modulator.

FIG. 8 is a side view of a light recycling integrator with mirrored segments in the color filter array associated with the exit face of the integrator.

FIG. 9 is a side view showing one embodiment of a hollow integrator associated with a stationary color filter array.

FIG. 10 is a side view showing one embodiment of a solid integrator rod with a color filter array attached to and spaced away from the end of the integrator rod.

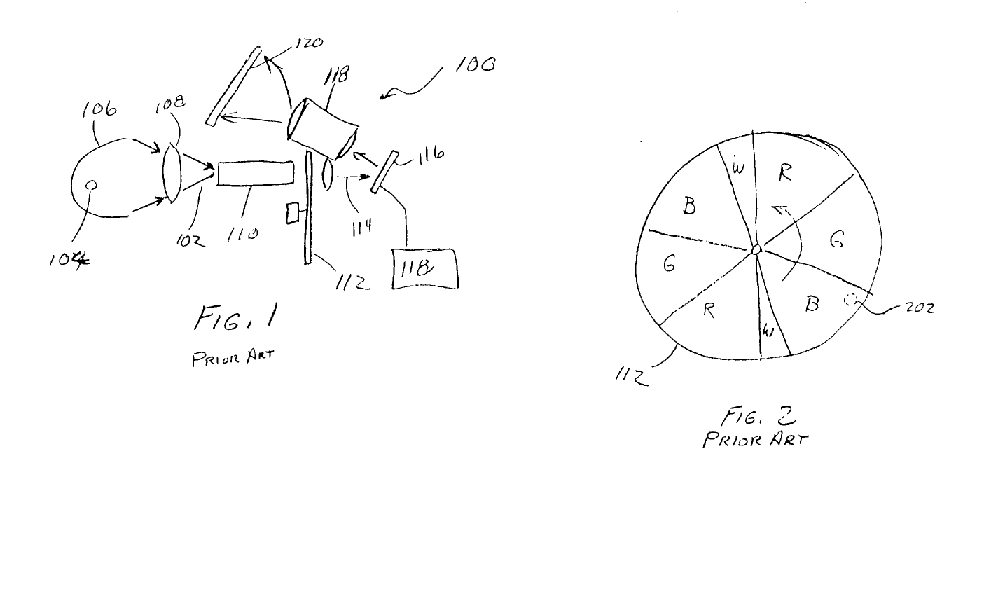

### DETAILED DESCRIPTION OF THE PREFERRED EMBODIMENTS

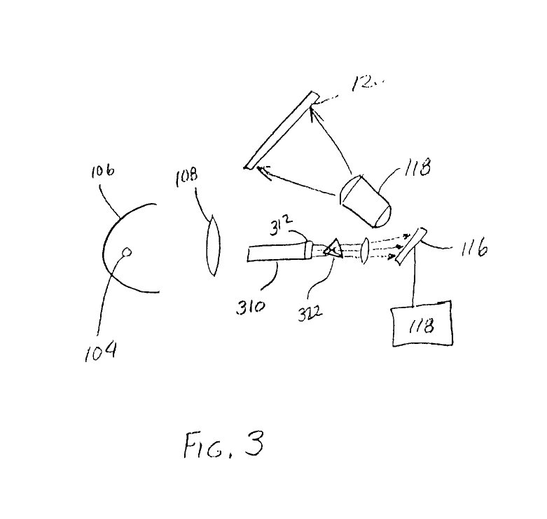

A new display system architecture has been developed that provides the efficiency improvements of sequential color recapture (SCR) display systems, but avoids the complexity of the spiral color wheel. FIG. 3 is a schematic diagram of the new display architecture. Two features of the display system 300 of FIG. 3 are a means for recycling and filtering light, shown as a stationary color filter array at the exit face of the integrating rod, and a scrolling element.

In FIG. 3, a color filter array 312 is positioned at the exit face of the integrator rod 310. The color filter array filters light reaching the end of the integrator rod into a plurality of colored light beams. As described above, each light beam will be referred to as a single color light beam even though it typically is comprised of a band of wavelengths. Anti-reflective coatings as well as protective coatings may be applied to the color filter array as well as to the input and exit faces of the integrating rod.

FIG. 4 is a perspective view of a solid integrator rod 110 of the prior art. The integrator rod 110 shown is a solid glass prism. Alternate embodiments provide a hollow rod with mirrored sides. The invention described herein may utilize either a hollow-or solid integrating rod. The input face 402 of the integrating rod 110 is mirrored, leaving an aperture 404 to allow light to enter the integrating rod 110. The exit face 406 is opposite the input face 402. The length of the integrating rod 110 is best determined by trial and error and depends on a variety of factors such as lamp arc size and stability, as well as the movement of the arc over time and the required uniformity of the light exiting the integrating rod 110.

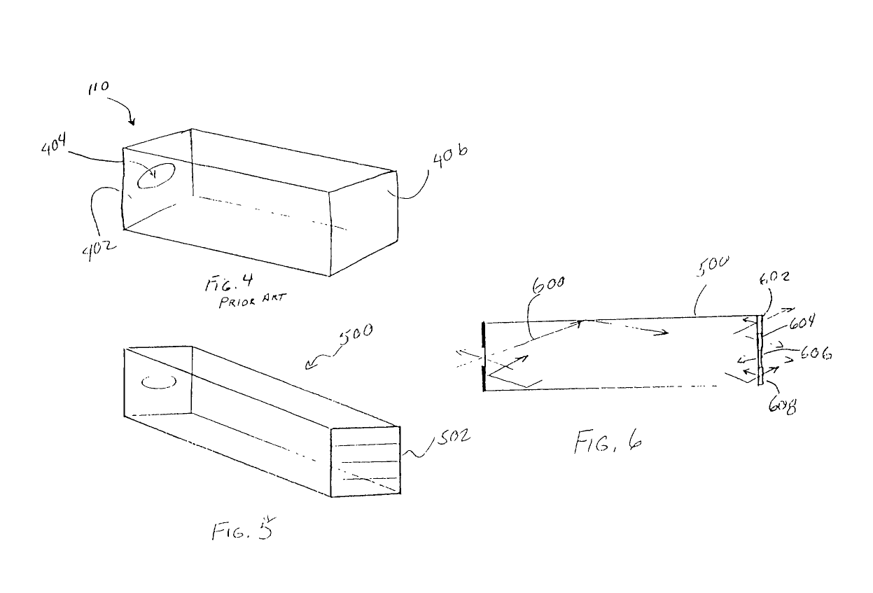

FIG. 5 is a perspective view of an integrating rod 500 according to one embodiment of the present invention. A color filter array 502 is located at the exit face of the integrating rod 500. The color filter array 502 shown in FIG. 5 includes four segments. One segment is dedicated to each primary color and the remaining color segment produces white light. Alternate embodiments of the integrating rod 500 do not include the white segment.

FIG. 6 is a side view of the integrating rod 500 of FIG. 5 showing the operation of the color filter array 502. In FIG. 6, polychromatic, or white light 600 enters the integrating rod through an aperture in the mirrored input face of the integrating rod. The white light travels down the integrating rod 500 reflecting from the sides of the rod. When the light reaches the end of the integrating rod it strikes one of the four segments of the color filter array 502.

The integrating rod 500 of FIG. 6 includes a red 602, white 604, blue 606, and green 608 filter segment, although other filters, combinations of filters, and arrangements of filters are equally useful. The red filter 602 passes light in the red band and reflects light outside the red band. The white filter 604, typically a clear segment or a segment with only an anti-reflective coating, typically passes light over the entire visible spectrum. The green filter 608 passes light in the green band and reflects light outside the green band. The blue filter 606 passes light in the blue band and reflects light outside the blue band.

Light reflected by one of the color filters of the color filter array 502 passes back through the integrating rod to the input face. If the reflected light strikes the mirrored input portion of the input face it is reflected and once again travels to the exit face of the integrating rod were it once again strikes the color filter array. The color filter array once again passes some components of the beam and reflects other components of the beam, depending on which filter segment is struck.

Returning to FIG. 3, the various single color light beams are directed by a scrolling element 322. Scrolling element 322 typically is a rotating prism that causes each single color beam to sweep across the face of the spatial light modulator 116. Although shown as transmissive in FIG. 3, reflective scrolling elements 322 may be used. Additionally, two or more elements, for example two rotating prisms, may be used to collimate or align the single colored light beams after they have been redirected.

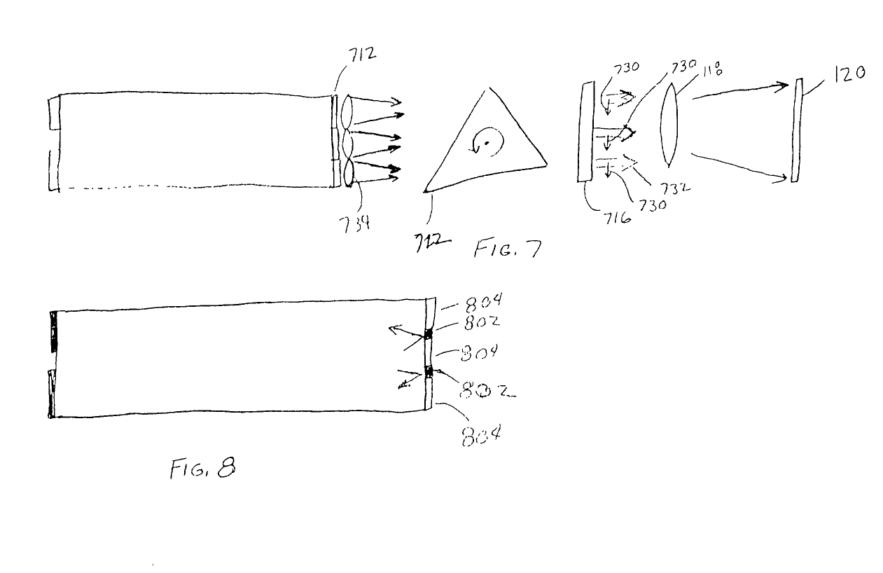

FIG. 7 is a schematic view of a portion of a display system showing the operation of the scrolling element 722 in combination with a transmissive spatial light modulator 716. Light from each segment of a three-segment color filter array 712 is directed by the scrolling element 722 to a portion of the spatial light modulator 716. As the scrolling element 722 rotates, the three single color light beams move across the modulator 716 as indicated by direction arrows 730. As a given color light beam scrolls off one side of the modulator 716 it is redirected by the scrolling element 722 to the opposite side of the modulator and continues to move across the face of the modulator 716.

Although three color filter segments are shown in FIG. 7, alternate embodiments may utilize two spatial light modulators and dedicate one of the spatial light modulators to a single color light. For example, one embodiment separates red light, typically the weakest of the three primary color beams, prior to entering the recycling integrator and directs it to a single red modulator panel. The remaining two colors are then separated by the color filter array and scrolled across the face of the second spatial light modulator.

The modulator 716 selectively modulates the single colored light beams in response to image data from a controller (not shown in FIG. 7). The modulated light beams 732 are focused onto an image plane 120 by projection lens 118. Although shown as a single lens in FIG. 7, like other lenses in this disclosure a multi-element lens system is typically used.

Also shown in FIG. 7 is an optional lens array 734. As illustrated, lens array 734 gathers the diverging beams of light exiting the color filter array and focuses them into converging or collimated beams. Focusing the single colored light beams into converging beams provides spatial separation which reduces the chance of the light being modulated by the image data for a different color. Another method of providing spatial separation between the light beams is shown in FIG. 8. In FIG. 8, mirrored segments 802 are provided between adjacent color filter segments 804. Light striking the mirrored segments is reflected, resulting in gaps between the single colored light beams passing through the color filter array.

To this point, the color filter array 312 has been described as located at the exit face of the integrator rod 310. There are many arrangements by which a color filter array 312 may be positioned at the end of the integrator rod 320. One embodiment deposits dichroic filters, or other filters, on the end of a solid integrating rod. While this embodiment uses no extra components, it may be difficult to form dichroic filters on the end of the glass rod. Alternatively, the filters may be formed separately and attached, for example glued, to the end of the rod.

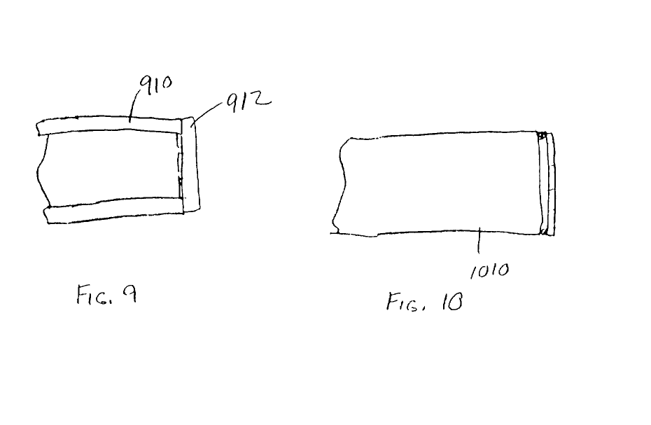

Alternatively, a separate color filter array 912 may be attached across the end of a hollow integrator rod 910, as shown in FIG. 9, or spaced apart from a solid integrator rod 1010 as shown in FIG. 10. The embodiment of FIG. 10 provides an air gap between the integrator rod and the color filter array. If a dichroic color filter array is used with the dichroic coatings on the side toward the integrator rod, the dichroic filters will be sheltered in the air gap away from contact with other components that could degrade the color filters.

Thus, although there has been disclosed to this point a particular embodiment for *** and method therefore etc., it is not intended that such specific references be considered as limitations upon the scope of this invention except insofar as set forth in the following claims. Furthermore, having described the invention in connection with certain specific embodiments thereof, it is to be understood that further modifications may now suggest themselves to those skilled in the art, it is intended to cover all such modifications as fall within the scope of the appended claims. In the following claims, only elements denoted by the words “means for” are intended to be interpreted as means plus function claims under 35 U.S.C. § 112, paragraph six.

What is claimed is:

1. An integrator rod comprising:
an integrator body having an input face and an output face; and
a color filter array associated in a fixed position with said output face.

2. The integrator rod of claim 1 comprising:
a mirrored coating on said input face, said mirrored coating forming an aperture.

3. The integrator rod of claim 1 comprising:
an antireflective coating on said input face.

4. The integrator rod of claim 1 comprising:
an antireflective coating on said exit face.

5. The integrator rod of claim 1 said color filter array comprising:
at least two color filter segments.

6. The integrator rod of claim 1 said color filter array comprising:
at least two dichroic color filter segments.

7. The integrator rod of claim 1 said color filter array comprising:
three color filter segments.

8. The integrator rod of claim 1 said color filter array comprising:
three dichroic color filter segments.

9. The integrator rod of claim 1 said color filter array comprising:
at least three color filter segments and a clear segment.

10. The integrator rod of claim 1 said color filter array formed on said exit face.

11. The integrator rod of claim 1 said color filter array attached to said exit face.

12. The integrator rod of claim 1 said color filter array glued onto said exit face.

13. The integrator rod of claim 1 said color filter array spaced apart from said exit face.

14. The integrator rod of claim 1 comprising:
a lens array aligned with said color filter array.

15. The integrator rod of claim 1 said integrator body comprising:
a solid prism.

16. The integrator rod of claim 1 said integrator body comprising:
a solid glass prism.

17. The integrator rod of claim 1 said integrator body comprising:
a hollow structure.

18. The integrator rod of claim 1 said integrator body comprising:
a hollow structure formed by mirrored walls.

19. The integrator rod of claim 1 said integrator body comprising:
a hollow structure formed by mirrored glass walls.

20. A display system comprising:
a recycling integrating rod on a light path for spatially filtering light traveling along said light path into at least two colored light beams;
a scrolling element for spatially altering the path of said at least two colored light beams;
a spatial light modulator receiving and modulating said at least two colored light beams; and
optics for focusing said modulated light beams on an image plane.

21. The display system of claim 20, further comprising:
a light source on said light path.

22. The display system of claim 20, further comprising:
a controller providing image data to said spatial light modulator.

23. The display system of claim 20, said spatial light modulator comprising a micromirror device.

24. The display system of claim 20, said spatial light modulator comprising a liquid crystal panel.

25. The display system of claim 20, said spatial light modulator comprising a liquid crystal panel formed on a silicon substrate.

26. The display system of claim 20, said scrolling element comprising at least one rotating prism.

27. The display system of claim 20, said scrolling element comprising at least one rotating reflective prism.

28. The display system of claim 20, said scrolling element comprising at least one rotating transmissive prism.

29. The display system of claim 20, said recycling integrating rod comprising:
an integrator body having an input face and an output face; and
a color filter array associated in a fixed position with said output face.

30. The display system of claim 29, said recycling integrating rod comprising:
a mirrored coating on said input face, said mirrored coating forming an aperture.

31. The display system of claim 29, said recycling integrating rod comprising:
an antireflective coating on said input face.

32. The display system of claim 29, said recycling integrating rod comprising:
an antireflective coating on said exit face.

33. The display system of claim 29, said recycling integrating rod comprising:
at least two color filter segments.

34. The display system of claim 29, said recycling integrating rod comprising:
at least two dichroic color filter segments.

35. The display system of claim 29, said recycling integrating rod comprising:
three color filter segments.

36. The display system of claim 29, said recycling integrating rod comprising:
three dichroic color filter segments.

37. The display system of claim 29, said recycling integrating rod comprising:
at least three color filter segments and a clear segment.

38. The display system of claim 29, said recycling integrating rod comprising:

39. The integrator rod of claim 29 said color filter array attached to said exit face.

40. The integrator rod of claim 29 said color filter array glued onto said exit face.

41. The integrator rod of claim 29 said color filter array spaced apart from said exit face.

42. The integrator rod of claim 29 comprising:
a lens array aligned with said color filter array.

43. The integrator rod of claim 29 said integrator body comprising:
a solid prism.

44. The integrator rod of claim 29 said integrator body comprising:
a solid glass prism.

45. The integrator rod of claim 29 said integrator body comprising:
a hollow structure.

46. The integrator rod of claim 29 said integrator body comprising:
a hollow structure formed by mirrored walls.

47. The integrator rod of claim 29 said integrator body comprising:
a hollow structure formed by mirrored glass walls.

48. A display system comprising:
a means for recycling and filtering light on a light path operable to filter said light into at least two colored light beams;
a scrolling element for spatially altering the path of said at least two colored light beams;
a spatial light modulator receiving and modulating said at least two colored light beams; and
optics for focusing said modulated light beams on an image plane.

49. The display system of claim 48, further comprising:
a light source on said light path.

50. The display system of claim 48, further comprising:
a controller providing image data to said spatial light modulator.

51. The display system of claim 48, said spatial light modulator comprising a micromirror device.

52. The display system of claim 48, said spatial light modulator comprising a liquid crystal panel.

53. The display system of claim 48, said spatial light modulator comprising a liquid crystal panel formed on a silicon substrate.

54. The display system of claim 48, said scrolling element comprising at least one rotating prism.

55. The display system of claim 48, said scrolling element comprising at least one rotating reflective prism.

56. The display system of claim 48, said scrolling element comprising at least one rotating transmissive prism.
